(19) United States
(12) Patent Application Publication
(10) Pub. No.: US 2023/0222848 A1
(43) Pub. Date: Jul. 13, 2023

(54) INFORMATION PROCESSING CENTER AND SYSTEM

(71) Applicant: TOYOTA JIDOSHA KABUSHIKI KAISHA, Toyota-shi (JP)

(72) Inventor: Yoshiyuki TAKAHARA, Toyota-shi (JP)

(73) Assignee: TOYOTA JIDOSHA KABUSHIKI KAISHA, Toyota-shi (JP)

(21) Appl. No.: 17/968,059

(22) Filed: Oct. 18, 2022

(30) Foreign Application Priority Data
Jan. 7, 2022 (JP) 2022-001643

(51) Int. Cl. G07C 5/00; H01M 10/48

(52) U.S. Cl. CPC G07C 5/008; H01M 10/486; H01M 2220/20

(57) ABSTRACT

An information processing center that is communicable with a vehicle includes: a reception unit configured to receive a state quantity of a battery mounted in the vehicle such as an internal resistance value, a temperature, and a state of charge of the battery from the vehicle; a derivation unit configured to derive estimated resistance information which is data obtained by estimating correspondence between the temperature and the internal resistance value of the battery based on the state quantity received by the reception unit when the internal resistance value received by the reception unit is equal to or greater than a predetermined resistance value; and a determination unit configured to determine whether an abnormality has occurred in the battery based on the estimated resistance information and deterioration resistance information which is data indicating the correspondence between the temperature and the internal resistance value in a deteriorated state of the battery.

### CROSS-REFERENCE TO RELATED APPLICATION

This application claims priority to Japanese Patent Application No. 2022-001643 filed on Jan. 7, 2022, incorporated herein by reference in its entirety.

### BACKGROUND

1. Technical Field

The present disclosure relates to an information processing center that can communicate with a vehicle and a system that includes the vehicle and the information processing center.

2. Description of Related Art

Japanese Unexamined Patent Application Publication No. 2000-206215 (JP 2000-206215 A) discloses a vehicular power supply diagnosis device that ascertains a terminal voltage and a current of a battery at the present time in a vehicle when the vehicle starts and when the vehicle is operating, compares the ascertained terminal voltage and the ascertained current with abnormality characteristic values of the battery stored in advance, and diagnoses an abnormality of the battery.

### SUMMARY

An internal resistance value which is used to diagnose an abnormality of a battery depends on a temperature of the battery. Accordingly, when an abnormality of a battery is diagnosed while a vehicle with a likelihood of change in a temperature of the battery is traveling as disclosed in JP 2000-206215 A, it may not be possible to perform accurate abnormality determination based on the internal resistance value. Therefore, there is room for new study in diagnosing an abnormality of a battery.

The present disclosure provides an information processing center and the like that can appropriately perform abnormality diagnosis for a battery mounted in a vehicle according to a change in temperature of the battery.

According to an aspect of the present disclosure, there is provided an information processing center that is able to communicate with a vehicle, the information processing center including: a reception unit configured to receive a state quantity of a battery mounted in the vehicle such as an internal resistance value, a temperature, and a state of charge of the battery from the vehicle; a derivation unit configured to derive estimated resistance information which is data obtained by estimating correspondence between the temperature and the internal resistance value of the battery based on the state quantity of the battery received by the reception unit when the internal resistance value of the battery received by the reception unit is equal to or greater than a predetermined resistance value; and a determination unit configured to determine whether an abnormality has occurred in the battery based on the estimated resistance information derived by the derivation unit and deterioration resistance information which is data indicating the correspondence between the temperature and the internal resistance value in a deteriorated state of the battery.

With the information processing center and the like according to the present disclosure, it is possible to appropriately perform abnormality diagnosis for a battery mounted in a vehicle according to a change in temperature of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration of a system including an information processing center according to an embodiment of the present disclosure;

FIG. 2 is a diagram illustrating a resistance line;

FIG. 3 is performed by the information processing center;

FIG. 4 is a flowchart illustrating an estimated resistance line updating process illustrated in FIG. 3;

FIG. 5 is a diagram illustrating an example of a standard resistance map for determining a standard resistance line;

FIG. 6 is a diagram illustrating an example of a deterioration resistance map for determining a deterioration resistance line;

FIG. 7 is a diagram illustrating an example of a reflection factor map in which a reflection factor is defined;

FIG. 8 is a diagram illustrating an abnormality diagnosis process for a battery which is performed by the information processing center; and

FIG. 9 is a diagram illustrating an abnormality diagnosis process for a battery which is performed by the information processing center.

### DETAILED DESCRIPTION OF EMBODIMENTS

According to the present disclosure, an information processing center that communicates with a vehicle dynamically changes a reference value for determining whether an abnormality has occurred in an onboard battery with a change of a physical quantity detected from the onboard battery and collected from the vehicle. Accordingly, the information processing center can appropriately perform abnormality diagnosis for the onboard battery according to a change in temperature or a progress in deterioration of the onboard battery.

Hereinafter, an embodiment of the present disclosure will be described in detail with reference to the accompanying drawings.

### Embodiment

### Configuration

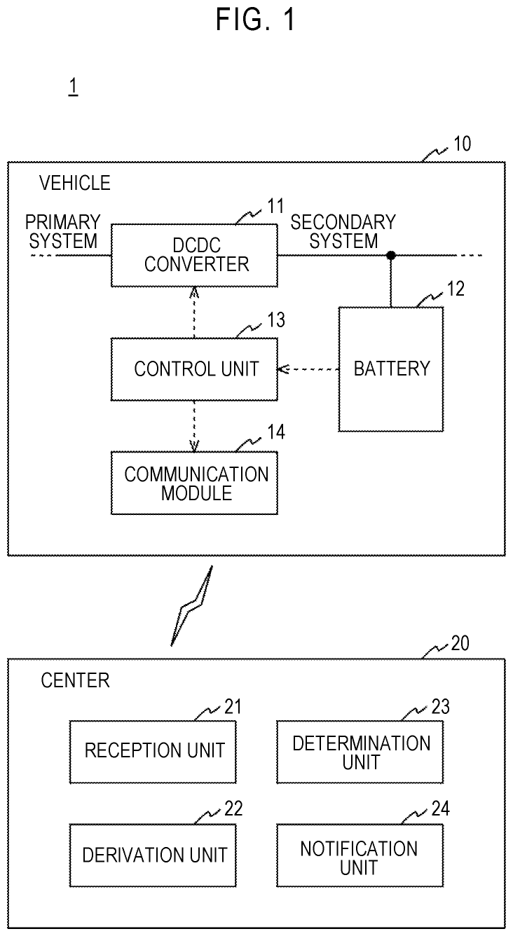

FIG. 1 is a block diagram schematically illustrating a configuration of a system 1 including an information processing center 20 according to an embodiment of the present disclosure. The system 1 illustrated in FIG. 1 includes a vehicle 10 and an information processing center 20.

The vehicle 10 is, for example, an electrified vehicle capable of autonomous driving. The vehicle 10 includes at least a DCDC converter 11, a battery 12, a control unit 13, and a communication module 14.

The DCDC converter 11 is a device that can convert electric power input from a primary system to which an electric motor, an alternator, a main battery, and the like (not illustrated) are connected to electric power of a predetermined voltage and output the converted electric power to a secondary system to which the battery 12, an auxiliary-machine load (not illustrated), and the like are connected.

The battery 12 is, for example, a secondary battery that is rechargeable such as a lithium-ion battery. The battery 12 stores electric power supplied from the primary system via the DCDC converter 11 or supplies electric power stored therein to an auxiliary-machine load (not illustrated) or the like connected to the secondary system. For example, the battery 12 is a so-called sub-battery that is redundantly provided such that electric power can be supplied as a backup instead of a main battery (not illustrated) connected to the primary system even when the main battery malfunctions at the time of autonomous driving of the vehicle 10.

The control unit 13 is constituted, for example, by an electronic control unit (ECU) including a microcomputer and can perform control of a charging/discharging current of the battery 12 in the DCDC converter 11, monitoring the state of the battery 12, and the like. In monitoring the state of the battery 12, the control unit 13 detects physical quantities (such as a voltage, a current, and a temperature) of the battery 12 using detection elements (such as a voltage sensor, a current sensor, and a temperature sensor) (not illustrated) provided in the battery 12 and acquires a state quantity of the battery 12 (hereinafter referred to as a “battery state”) including an internal resistance value, a temperature, and a state of charge (SOC) of the battery 12 based on the detected physical quantities of the battery 12. The acquired battery state is output to the communication module 14.

The communication module 14 is a communication device that has a function of controlling communication between the information processing center 20 and the vehicle 10. The communication module 14 is wirelessly connected to the information processing center 20, for example, via a network which is not illustrated and transmits information on the vehicle 10 including the state of the battery 12 (the battery state) or the like output from the control unit 13 to the information processing center 20 (a transmission unit).

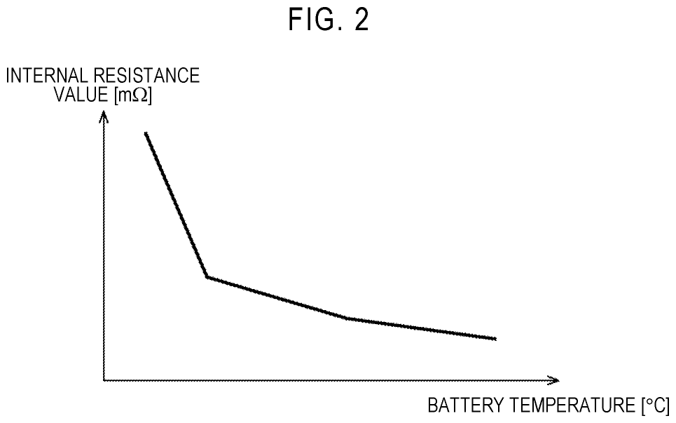

The information processing center 20 is communicatively connected to the vehicle 10 and performs various processes for the vehicle 10. As one executable process, the information processing center 20 can diagnose whether an abnormality has occurred in the battery 12 mounted in the vehicle 10 based on various types of information which can be acquired from the vehicle 10 using resistance information indicating characteristics of the battery 12. This resistance information is data indicating correspondence between the temperature and the internal resistance value which are physical quantities of the battery 12. In this embodiment, a resistance line which is a line of data indicating correspondence between the temperature and the internal resistance value of the battery 12 as illustrated in FIG. 2 is used as resistance information. Regarding an abnormality diagnosis process of the battery 12, the information processing center 20 includes a reception unit 21, a derivation unit 22, a determination unit 23, and a notification unit 24.

The reception unit 21 receives the battery state including the internal resistance value, the temperature, and the state of charge of the battery 12 from the vehicle 10. The reception unit 21 may periodically receive the battery state from the vehicle 10 and may receive the battery state at only a predetermined timing determined by the information processing center 20.

The derivation unit 22 derives an estimated resistance line (estimated resistance information) which is a line of data obtained by estimating the correspondence between the temperature (hereinafter referred to as a “detected temperature”) and the internal resistance value (hereinafter referred to as a “detected resistance value”) when the physical quantities of the battery 12 have been detected on the basis of the battery state received from the reception unit 21. Details of the estimated resistance line will be described later. The estimated resistance line is reconsidered whenever the battery state of the battery 12 is newly received by the reception unit 21 and is updated according to necessity.

The determination unit 23 performs an abnormality diagnosis process of determining whether an abnormality has occurred in the battery 12 based on the estimated resistance line derived by the derivation unit 22 and a deterioration resistance line (deterioration resistance information) which is a line of data indicating the correspondence between the temperature and the internal resistance value in the deteriorated state of the battery 12. Details of the abnormality diagnosis process of the battery 12 will be described later.

When the determination unit 23 determines that an abnormality has occurred in the battery 12, the notification unit 24 notifies that an abnormality has occurred.

The reception unit 21, the derivation unit 22, the determination unit 23, and the notification unit 24 can be typically constituted by a control device including a processor, a memory, and an input/output interface. The control device realizes all or some of the functions of the reception unit 21, the derivation unit 22, the determination unit 23, and the notification unit 24 by causing the processor to read and execute a program stored in the memory.

### Control

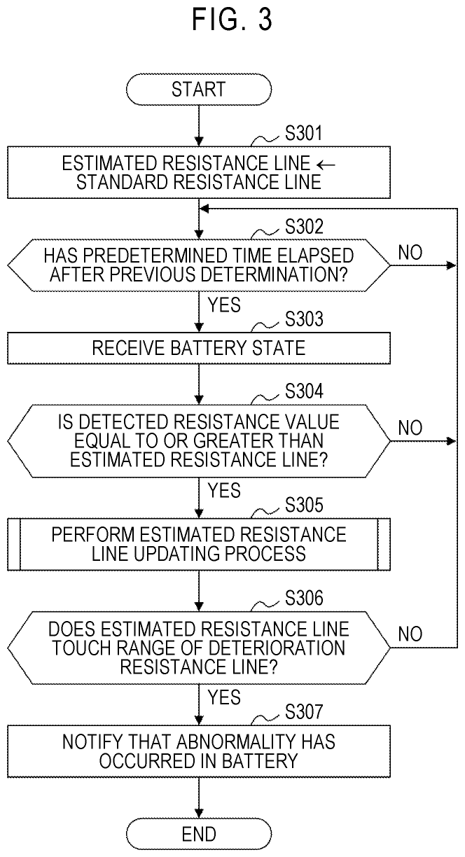

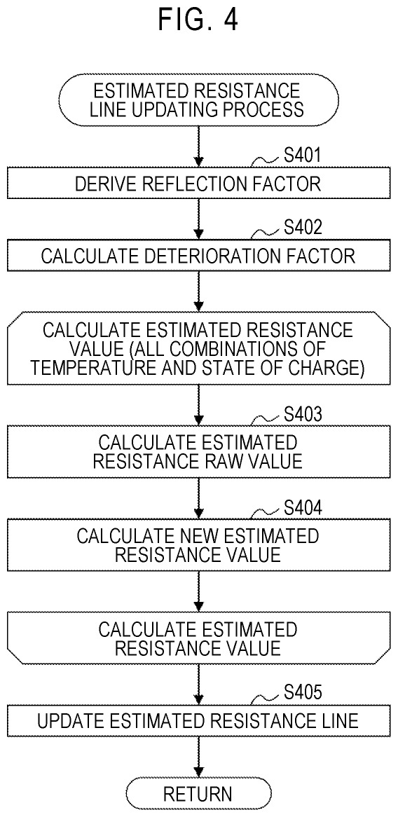

Control which is performed by the information processing center 20 according to this embodiment will be described below with additional reference to FIGS. 3 and 4. FIG. 3 is a flowchart illustrating a routine of the abnormality diagnosis process of the battery 12 which is performed by the constituents of the information processing center 20. FIG. 4 is a flowchart illustrating a detailed routine of an estimated resistance line updating process (Step S305) illustrated in FIG. 3.

The information processing process illustrated in FIG. 3 is started, for example, when the information processing center 20 first recognizes the vehicle 10 (the battery 12) because the vehicle 10 is registered in the information processing center 20 or when the information processing center 20 recognizes replacement of the battery 12 mounted in the vehicle 10.

### Step S301

The derivation unit 22 sets a standard resistance line which is a line of data indicating the correspondence between the temperature and the internal resistance in an unused state (a new-product state) of the battery 12 as an initial value of the estimated resistance line. The standard resistance line is prepared by a manufacturer of the battery 12 or the vehicle 10 or the like in advance.

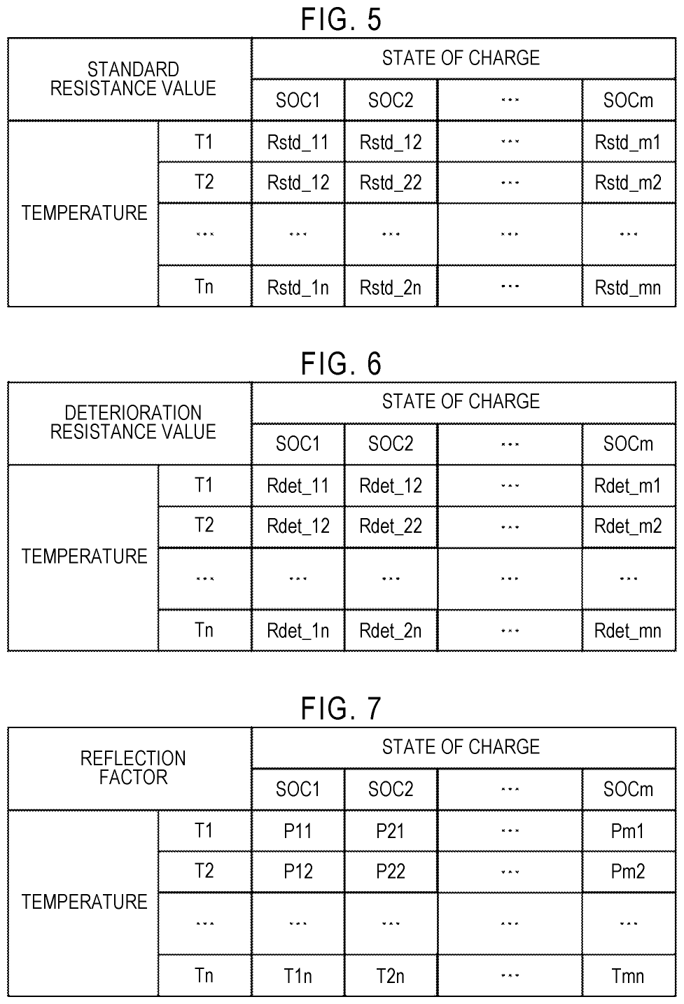

FIG. 5 illustrates an example of a standard resistance map for determining the standard resistance line. As illustrated in FIG. 5, the standard resistance map is a two-dimensional correspondence table in which a resistance value Rstd in an unused state (a new-product state) of the battery 12 can be defined using the temperature [° C.] and the state of charge [%] of the battery 12 as parameters. In the standard resistance map illustrated in FIG. 5, for example, it is shown that the standard resistance value is “Rstd_21” when the state of charge of the battery 12 is “SOC2” and the temperature is “T1.”

When the standard resistance line is initially set as the estimated resistance line, the routine proceeds to Step S302.

### Step S302

The determination unit 23 determines whether a predetermined time has elapsed after abnormality diagnosis for the battery 12 has been previously performed. This determination is performed to periodically determine an abnormality of the battery 12. The predetermined time can be arbitrarily set based on accuracy of the abnormality diagnosis result required for the battery 12. When the predetermined time has elapsed after abnormality diagnosis for the battery 12 has been previously performed (YES in Step S302), the routine proceeds to Step S303.

### Step S303

The reception unit 21 receives a detected resistance value Rpre, a detected temperature Tpre, and a detected state of charge SOCpre which are the internal resistance value, the temperature, and the state of charge of the battery 12 at the present time as the battery state from the vehicle 10. When the battery state is received from the vehicle 10, the routine proceeds to Step S304.

### Step S304

The determination unit 23 determines whether the detected resistance value Rpre of the battery 12 is equal to or greater than the estimated resistance line. This determination is performed not to diagnose the abnormality of the battery 12 based on the battery state when the battery state received from the vehicle 10 is erroneous. More specifically, the determination unit 23 determines whether the detected resistance value Rpre of the battery 12 received by the reception unit 21 is equal to or greater than a resistance value Rest_Tpre which is an estimated resistance value Rest corresponding to the detected temperature Tpre of the battery 12 in the estimated resistance line (in the estimated resistance information).

When the detected resistance value Rpre of the battery 12 is equal to or greater than the estimated resistance line (Rpre≥Rest_Tpre) (YES in Step S304), the routine proceeds to Step S305. On the other hand, when the detected resistance value Rpre of the battery 12 is less than the estimated resistance line (Rpre<Rest_Tpre) (NO in Step S304), the routine proceeds to Step S302.

### Step S305

The derivation unit 22 performs a process of updating the estimated resistance line. That is, the estimated resistance line updating process is performed when the internal resistance value (the detected resistance value Rpre) of the battery 12 is equal to or greater than a predetermined resistance value (the estimated resistance line). The estimated resistance line updating process will be described later. When the estimated resistance line updating process is completed, the routine proceeds to Step S306.

### Step S306

The determination unit 23 determines whether the estimated resistance line touches the deterioration resistance line. This determination is performed to determine whether an abnormality has occurred in the battery 12. The deterioration resistance line is a line of data indicating the correspondence between the temperature and the internal resistance value in the deteriorated state of the battery 12. The deterioration resistance line is prepared by a manufacturer of the battery 12 or the vehicle 10 or the like in advance.

FIG. 6 illustrates an example of a deterioration resistance map for defining a deterioration resistance line. As illustrated in FIG. 6, the deterioration resistance map is a two-dimensional correspondence table in which a resistance value Rdet in the deteriorated state of the battery 12 can be defined using the temperature [° C.] and the state of charge [%] of the battery 12 as parameters. In the deterioration resistance map illustrated in FIG. 6, it is shown that the deterioration resistance value is “Rdet_21” when the state of charge of the battery 12 is “SOC2” and the temperature is “T1.”

The “estimated resistance line touches the deterioration resistance line” means that the estimated resistance value Rest of the estimated resistance line is greater than the deterioration resistance value Rdet of the deterioration resistance line at least at some temperatures.

When the estimated resistance line touches the deterioration resistance line (YES in Step S306), it is determined that an abnormality has occurred in the battery 12 and the routine proceeds to Step S307. On the other hand, when the estimated resistance line does not touch the deterioration resistance line (NO in Step S306), it is determined that an abnormality has not occurred in the battery 12, and the routine proceeds to Step S302.

### Step S307

The notification unit 24 notifies that an abnormality has occurred in the battery 12. Typically, this notification is performed to the outside of the information processing center 20. For example, the notification unit 24 may perform notification to notify a service provider using the vehicle 10 that there is a likelihood that a service which is being provided will stop with stopping of the vehicle 10. When it is notified that an abnormality has occurred in the battery 12, the abnormality diagnosis process of the battery 12 ends.

In the estimated resistance line updating process of Step S305 illustrated in FIG. 3, Steps S401 to S404 illustrated in FIG. 4 are performed.

### Step S401

The derivation unit 22 derives a reflection factor. The reflection factor is a coefficient for determining to what extent the current state of the battery 12 is reflected in the estimated resistance line to be updated. This reflection factor is determined in advance by a manufacturer of the battery 12 or the vehicle 10.

FIG. 7 illustrates an example of a reflection factor map in which a reflection factor is defined for each condition. As illustrated in FIG. 7, the reflection factor map is a two-dimensional correspondence table in which a reflection factor which is applied to each resistance value Rest of the estimated resistance line is defined using the temperature [° C.] and the state of charge [%] of the battery 12 as parameters. In the reflection factor map illustrated in FIG. 7, for example, it is shown that the reflection factor is “P21” when the state of charge of the battery 12 is “SOC2” and the temperature is “T1.” Since a change of the internal resistance value of the battery 12 is greater in a low-temperature area than in a high-temperature area, detection accuracy of a resistance value in the high-temperature area is lowered. Accordingly, it is preferable that the reflection factor be set to be higher in the lower-temperature area than in the high-temperature area in consideration of a detection error of the resistance value.

The derivation unit 22 derives a “reflection factor Ppre” which is a reflection factor corresponding to the detected temperature Tpre and the detected state of charge SOCpre based on the detected temperature Tpre and the detected state of charge SOCpre of the battery 12. When the reflection factor Ppre is derived, the routine proceeds to Step S402.

### Step S402

The derivation unit 22 derives a deterioration factor. The deterioration factor is a coefficient indicating to what extent the current state of the battery 12 has deteriorated from a new-product state. The derivation unit 22 derives a “deterioration factor Dpre” which is a deterioration factor based on the detected resistance value Rpre, the detected temperature Tpre, and the detected state of charge SOCpre of the battery 12 using [Expression 1]. In [Expression 1], a standard resistance value Rstd_pre is a resistance value of a the standard resistance line corresponding to the detected temperature Tpre and the detected state of charge SOCpre, and a deterioration resistance value Rdet_pre is a resistance value of the deterioration resistance line corresponding to the detected temperature Tpre and the detected state of charge SOCpre. When the deterioration factor Dpre is derived, the routine proceeds to Step S403.

Deterioration factor Dpre=(detected resistance value Rpre−standard resistance value Rstd_pre)/(deterioration resistance value Rdet_pre−standard resistance value Rstd_pre) [Expression 1]

A process of calculating an estimated resistance value in Steps S403 and S404 which will be described later is repeatedly performed on each of all combinations (mxn sets) of m (where m is a predetermined positive integer) states of charge from the state of charge SOC1 to the state of charge SOCm which can be taken by the battery 12 and n (where n is a predetermined positive integer) temperatures from the temperature T1 to the temperature Tn which can be taken by the battery 12.

### Step S403

The derivation unit 22 calculates an estimated resistance raw value R′est_xy based on a combination of a state of charge SOCx (where x is one of 1 to m) and a temperature Ty (where y is one of 1 to n). The estimated resistance raw value R′est_xy is calculated by [Expression 2] using the standard resistance value Rstd_xy corresponding to the state of charge SOCx and the temperature Ty on the standard resistance line, the deterioration resistance value Rdet_xy corresponding to the state of charge SOCx and the temperature Ty on the deterioration resistance line, and the deterioration factor Dpre. When the estimated resistance raw value R′est_xy is calculated, the routine proceeds to Step S404.

Estimated resistance raw value R′est_xy=standard resistance value Rstd_xy+(deterioration resistance value Rdet_xy−standard resistance value Rstd_xy)×deterioration factor Dpre [Expression 2]

### Step S404

The derivation unit 22 calculates a new estimated resistance value Rest_new_xy based on the combination of the state of charge SOCx and the temperature Ty. The new estimated resistance value Rest_new_xy is calculated by [Expression 3] using the estimated resistance raw value R′est xy calculated based on the state of charge SOCx and the temperature Ty, the estimated resistance value Rest_xy corresponding to the state of charge SOCx and the temperature Ty on the estimated resistance line which is currently set, and the reflection factor Ppre. When the new estimated resistance value Rest_new_xy is calculated, the routine proceeds to Step S405.

New estimated resistance value Rest_new_xy=estimated resistance value Rest_xy+(estimated resistance raw value R′est_xy−estimated resistance value Rest_xy)×reflection factor Ppre [Expression 3]

### Step S405

When the new estimated resistance value Rest_new_xy is calculated for all the combinations of the state of charge and the temperature which can be taken by the battery 12, the derivation unit 22 newly sets a new estimated resistance line which is a line of data including the plurality of calculated estimated resistance values Rest_new and updates the estimated resistance line. When the estimated resistance line is updated, the estimated resistance line updating process ends and the routine proceeds to Step S306.

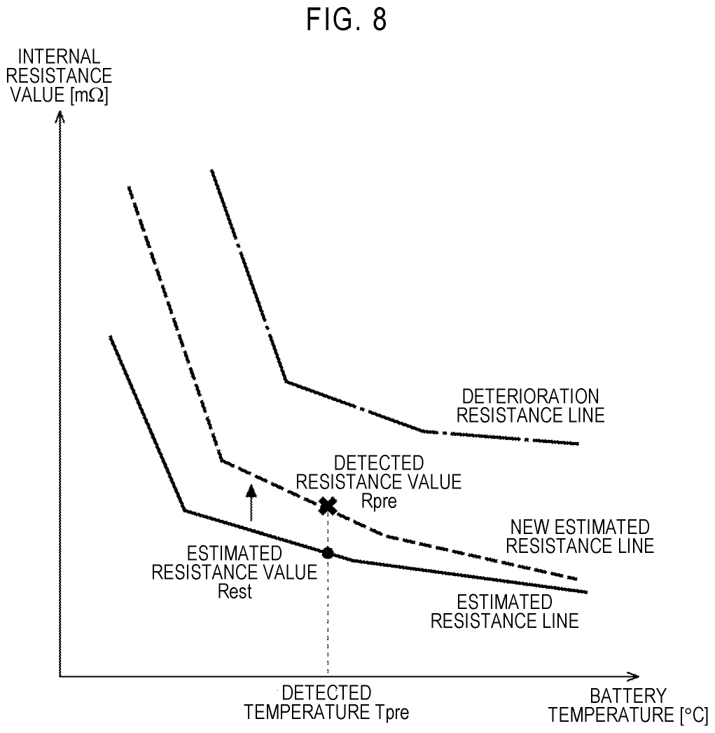

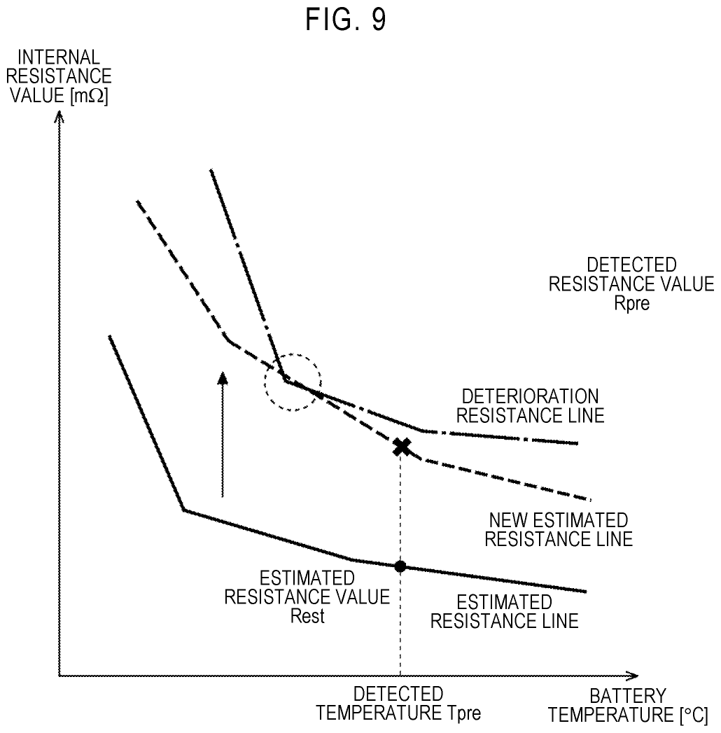

The abnormality diagnosis process of the battery 12 which is performed by the information processing center 20 will be described below with additional reference to FIGS. 8 and 9.

In the example illustrated in FIG. 8, the detected resistance value Rpre (mark x) received from the vehicle 10 by the information processing center 20 is greater than the estimated resistance value Rest (mark ●) on the estimated resistance line at the detected temperature Tpre. Accordingly, the estimated resistance line used for the abnormality diagnosis process of the battery 12 is updated from the currently set estimated resistance line (a solid line) to the new estimated resistance value Rest (a dotted line) calculated based on the detected values (the resistance values, the temperatures, and the states of charge) (the line is corrected upward to increase the resistance value). In the example illustrated in FIG. 8, since the updated new estimated resistance line does not touch the deterioration resistance line, it is not determined yet that an abnormality has occurred in the battery 12.

In the example illustrated in FIG. 9, the new estimated resistance line (a dotted line) updated similarly to FIG. 8 is less than the deterioration resistance value at the detected resistance value Rpre (mark x), but a part indicated by a dotted circle touches the deterioration resistance line. Accordingly, it is determined that an abnormality has occurred in the battery 12.

### OPERATIONS AND ADVANTAGES

With the information processing center 20 according to the embodiment of the present disclosure, when abnormality diagnosis for the battery 12 is performed based on the battery state (the state quantity of the battery) including the internal resistance value, the temperature, and the state of charge of the battery 12 which is received from the vehicle 10, the estimated resistance line (estimated resistance information) which is used for the abnormality diagnosis is newly derived and updated whenever the internal resistance value of the battery 12 becomes equal to or greater than the resistance value of the currently set estimated resistance line. Through this process, it is possible to optimally set the estimated resistance line which is used for the abnormality diagnosis according to the temperature or the degree of deterioration in an actual environment of the battery 12. Accordingly, it is possible to appropriately perform abnormality diagnosis for the battery 12 mounted in the vehicle according to a change in temperature or a progress in deterioration of the battery.

With the information processing center 20 according to the embodiment, a service provider or the like is notified that an abnormality has occurred in the battery 12. Through this process, the service provider or the like can ascertain deterioration of the battery 12 before backup using the battery 12 becomes impossible. Accordingly, for example, it is possible to avoid occurrence of an event in which a battery pack needs to be replaced with deterioration of the battery 12 and provision of a service needs to be temporarily stopped while an Maas provider is operating a mobility service using the vehicle 10.

While an embodiment of the present disclosure has been described above, the present disclosure can be understood as a control method which is performed by a center, a control program, a non-transitory computer-readable recording medium storing the control program, or a system including an information processing center and a vehicle in addition to the information processing center.

The information processing center or the like according to the present disclosure is applicable to a case in which an abnormality of a battery mounted in a vehicle is diagnosed or the like.

What is claimed is:

1. An information processing center that is able to communicate with a vehicle, the information processing center comprising:
a reception unit configured to receive a state quantity of a battery mounted in the vehicle such as an internal resistance value, a temperature, and a state of charge of the battery from the vehicle;
a derivation unit configured to derive estimated resistance information which is data obtained by estimating correspondence between the temperature and the internal resistance value of the battery based on the state quantity of the battery received by the reception unit when the internal resistance value of the battery received by the reception unit is equal to or greater than a predetermined resistance value; and
a determination unit configured to determine whether an abnormality has occurred in the battery based on the estimated resistance information derived by the derivation unit and deterioration resistance information which is data indicating the correspondence between the temperature and the internal resistance value in a deteriorated state of the battery.

2. The information processing center according to claim 1, wherein the determination unit is configured to determine that an abnormality has occurred in the battery when a resistance value of the estimated resistance information is greater than a resistance value of the deterioration resistance information at least at some temperatures.

3. The information processing center according to claim 1, wherein the predetermined resistance value is a resistance value corresponding to the temperature of the battery received by the reception unit in the estimated resistance information previously derived by the derivation unit.

4. The information processing center according to claim 1, wherein the reception unit is configured to receive the state quantity of the battery from the vehicle when a predetermined time has elapsed after the determination unit has previously determined whether an abnormality has occurred in the battery.

5. The information processing center according to claim 1, further comprising a notification unit configured to notify that an abnormality has occurred when the determination unit has determined that an abnormality has occurred in the battery.

6. A system comprising:
a vehicle and; and
an information processing center that is able to communicate with the vehicle, wherein the vehicle includes:
a control unit configured to acquire a state quantity of a battery mounted in the vehicle such as an internal resistance value, a temperature, and a state of charge of the battery; and
a transmission unit configured to transmit the state quantity of the battery acquired by the control unit to the information processing center, and
wherein the information processing center includes:
a reception unit configured to receive the state quantity of the battery from the vehicle;
a derivation unit configured to derive estimated resistance information which is data obtained by estimating correspondence between the temperature and the internal resistance value of the battery based on the state quantity of the battery received by the reception unit when the internal resistance value of the battery received by the reception unit is equal to or greater than a predetermined resistance value; and
a determination unit configured to determine whether an abnormality has occurred in the battery based on the estimated resistance information derived by the derivation unit and deterioration resistance information which is data indicating the correspondence between the temperature and the internal resistance value in a deteriorated state of the battery.
